(19) United States
(12) Patent Application Publication
(10) Pub. No.: US 2014/0000459 A1
(43) Pub. Date: Jan. 2, 2014

(54) DEVICE FOR SEPARATING MEDIA

(71) Applicants: Sven Wozniak, Konstanz (DE); Veronika Erber, Friedrichshafen (DE)

(72) Inventors: Sven Wozniak, Konstanz (DE); Veronika Erber, Friedrichshafen (DE)

(21) Appl. No.: 13/261,666

(22) PCT Filed: Oct. 28, 2011
(86) PCT No.: PCT/EP11/05469

§ 371 Date: Sep. 10, 2013

(30) Foreign Application Priority Data
Dec. 9, 2010 (DE) 10 2010 053 922.8

(51) Int. Cl. B01D 19/00

(52) U.S. Cl. CPC B01D 19/0063
USPC 96/174

(57) ABSTRACT

The invention relates to a device for separating media, in particular for removing gases, such as air, from a fluid, such as oil, comprising a separating apparatus (10), which causes the medium to rotate upon entering the separating apparatus for the purpose of carrying out the separation and which has one outlet point (14, 12) each for the gas and for the fluid, said outlet points being separated from each other, wherein the device for separating media is characterized in that the separating apparatus (10) has a bypass valve (16), which is arranged downstream of the fluid flow and upstream of the outlet point (12) for the fluid and through which at least part of the medium flows to the outlet point (12) for the fluid in order to bypass the region of the separating apparatus (10) designed to remove gas front the fluid, provided the medium in the vicinity of the bypass valve (16) exerts a pressure sufficient to open the bypass valve (16).

The invention relates to a device for separating media, in particular for removing gases, such as air, from a fluid, such as an oil, comprising a separating apparatus, which causes the medium to rotate upon entering the separating apparatus for the purpose of carrying out the separation and which has one outlet point each for the gas and for the fluid, respectively.

DE 10 2008 029 203 A1 discloses a device of this class for separating media that comprises, extending along the separating apparatus, a filter device having at least one filter mat web, which provides for the medium to traverse the filter mat web toward the separating apparatus. Also configured in the known device is a bypass device with individual valves that are executed as spring-loaded check valves and that maintain the function of the device for separating media, even when the filter mat web is clogged by dirt causing it to be blocked. Should a clogging situation occur, the filter mat web of the filter device is circumvented in the manner of a bypass circuit, and, by opening the bypass device, the contaminated fluid reaches the separating apparatus directly for the purpose of performing the phase separation of gas/fluid. This is why, with the known device, a contaminated filter mat web does not result in an interruption of the fluid flow supplied by the device for separating media, for example, in the form of a hydraulic oil supplied to a connected hydraulic circuit.

Based on this prior art, the underlying object of the present invention is to provide a device for separating media that, aside from an effective separation of gases from fluids, ensures better operational reliability.

Due to the fact that, according to the characterizing portion of claim 1, the separating apparatus includes a bypass valve that is disposed downstream of the fluid flow and upstream of the outlet point for the fluid and by which at least a part of the medium flows, bypassing the area of the separating apparatus that is intended for separating the gas from the fluid, to the outlet point for the fluid, provided the medium exerts a sufficient amount of pressure in the region of the bypass valve to open the bypass valve; this means even in cases when the entry of the medium into the separating apparatus is restricted, for example due to contamination inside the separating apparatus, a continuous supply to a consumer connected to the device for separating media is ensured, for example by way of a connected hydraulic circuit. Furthermore, by means of the device according to the invention, it is ensured that in the presence of a brief increase of the flow of medium into the device, which may not be able to enter the separating apparatus completely, the surplus medium flows via the bypass valve to the outlet point for the fluid, such that damage to the device for separating media due to temporarily occurring excess pressure is avoided.

In one embodied example of the device according to the invention, the device for separating media has a tubular configuration, and the bypass valve closes the separating apparatus at one end while constituting an outlet point for the fluid/medium on the free end thereof.

This way, the separating apparatus has a compact structure and is produced simply and cost-effectively.

In one embodied example of the device according to the invention for separating media, said device comprises, extending along the separating apparatus, a filter device that includes at least one filter mat web, and the medium traverses the filter mat web toward the separating apparatus. This way, a pre-cleaning of the medium is achieved prior to the medium entering the separating apparatus, such that the action of separating gases from the fluid inside the separating apparatus can be achieved as effectively as possible. Furthermore, due to the pre-cleaning step, contamination of the actual separating apparatus by dirt particles and thereby compromising it in terms of its function, is also avoided. Owing to the corresponding setup structure, which provides preferably for the filter mat web and separating apparatus to be disposed at a radial distance relative to each other at least over a part of the longitudinal extension thereof, a fluid space is created between the filter mat web of the filter device and the separating apparatus into which the medium enters after it has traversed the filter mat web in order to finally enter the separating apparatus.

If the pressure of the medium inside the fluid space exceeds a value that can be preset, as a consequence, the bypass valve is opened and the medium leaves the fluid space at least in part through the bypass valve in the direction of the outlet point for the fluid. Such a pressure increase of the medium occurs, for example, when the medium is unable to enter the separating apparatus, either altogether or only to a limited degree. Even an inflow of medium into the device that is increased only briefly and cannot enter the separating apparatus completely can thereby be circulated to the outlet point for the fluid.

In one embodied example of the device according to the invention for separating media, the device includes a further bypass valve by which at least a part of the medium flows to the outlet point for the fluid bypassing the filter device, when the filter device exerts a high flow resistance on the flow of the medium that is high enough for the correspondingly generated pressure of the medium to open the further bypass valve. Particularly after extended use of the device without replacing the filter device, said device can become partially clogged or even completely blocked. To ensure a continuous supply of fluid to a consumer that is connected to the device, the so-called further bypass valve is provided. Naturally, instead of a single further bypass valve, it is possible to provide an array of a plurality of bypass valves, for example two or four bypass valves, that are able to provide said functions, thereby further improving the operational reliability of the device. Owing to this redundancy, the operational reliability of the device for separating media is further enhanced.

The medium exiting the further bypass valve in the event of a contamination of the filter device that thereby circumvents the filter device, passes through the fluid space formed between the separating apparatus and the filter device, and it enters the separating apparatus. If the separating apparatus is unable to accommodate the supplied medium, partially or not at all, for example due to contamination of the filter, said medium is at least in part routed via the bypass valve of the separating apparatus in order for it to flow to the outlet point for the fluid.

In one embodied example of the device according to the invention for separating media, the further bypass valve is disposed at the end of the separating apparatus at the opposite the end of where the bypass valve of the separating apparatus is disposed.

Such an arrangement of the bypass valve and the further bypass valve relative to the separating apparatus is advantageous in that the further bypass valve is disposed herein in close proximity to the location of the separating apparatus where medium enters the separating apparatus, such that a connecting path is provided that is a short as possible. Furthermore, if the further bypass valve is open, the part of the medium that cannot be accommodated by the separating apparatus can enter the fluid space that is formed between the separating apparatus and the filter mat web directly and is able to travel along the same and without impediment in order to reach the bypass valve of the separating apparatus that is disposed at the other end of the separating apparatus.

In one embodied example of the device according to the invention for separating media, the separating apparatus includes at least two tubular sections that can be separated from each other and that are disposed coaxially relative to each other in the assembled state providing sealing action against each other. One tubular section of the separating apparatus therein can include the cyclone separator, while the other tubular section, which can be separated from the first section, includes the bypass valve of the separating apparatus. By the sealing action of the tubular sections of the separating apparatus relative to each other, it is ensured that the media flow does not escape from the inside of the separating apparatus into the fluid space that is formed between the separating apparatus and the filter device. Due to the two-part configuration of the separating apparatus, the adjustment of said apparatus to different longitudinal extensions of the device for separating media is simplified, wherein it is sufficient to adjust the longitudinal extension of one of the two tubular sections of the separating apparatus in the longitudinal direction of the extension of the device.

In one embodied example of the device according to the invention for separating media, the flow direction of the separating apparatus is located downstream, and a preload valve for safeguarding a minimum pressure of the fluid exiting the device and/or medium is disposed at the outlet point thereof. A hydraulic circuit that is connected to the device for separating media typically requires a preset minimum pressure of the supplied fluid and/or medium that must be maintained. The arrangement of the preload valve provided for this purpose is disposed downstream of the separating apparatus and at the outlet point, and it ensures that with the envisioned, normal operating functionality of the device for separating media, which provides for the medium to flow first thought the filter mat web and subsequently through the separating apparatus, a minimum pressure of the exiting fluid is always ensured even if the one and/or the further bypass valves is opened in the event of a malfunction in the course of normal operation.

In one embodied example of the device according to the invention for separating media, the tubular section of the separating apparatus, which is adjacent to the outlet point for gas, has a tapered inside diameter over a part of the longitudinal extension of the section in the direction of the outlet point for the fluid that supports the separation of gas from the fluid in the manner of a cyclone separator. Cyclone separators of this kind are known in the art, for example based on the cited specification DE 10 2008 029 203 A 1, which is why any further explanation can be omitted here.

In one embodied example of the device according to the invention for separating media, the end regions of the at least two tubular sections of the separating apparatus that are directed toward each other are axially overlapping; in particular, one of the end regions is inserted into the other end region and retained therein by fastening means. This way, a simple and cost-effective possibility for connecting the two tubular sections of the separating apparatus has been created which, moreover, allows, at least within limits, for an adjustment of the longitudinal extension

of the separating apparatus, such that manufacturing tolerances with regard to the longitudinal extension of the device or the separating apparatus can, at least in part, be compensated for at the connecting point. The corresponding fastening means can be, in particular, a locking means, in that the inserted end region of the tubular section has locking grooves around the outer circumference thereof that act in conjunction with the corresponding locking catches of the coaxially outer end region of the further tubular section of the separating apparatus. To provide for a certain amount of elasticity of the inserted end region, said region can be slotted at the front face in the axial direction over a part of the longitudinal extension of the same, thus allowing for easy insertion while the provided fastening means, particularly a type of locking means, ensures a sufficient amount of an axial fixation of the tubular sections against each other. To guarantee that the connecting point of the tubular sections is sealed, it is possible to provide a circumferential mating surface particularly in a non-slotted section of the inserted end region that can be brought to rest in a sealing fashion against a corresponding internal mating surface of the coaxial outer end region of the further tubular section. Alternatively, or additionally, a seal in the form of an O ring can be provided between the two end regions. Preferably, the tubular section that is inserted in the further tubular section includes a cyclone separator in the proximity of the free end thereof, such that, in the assembled state of the separating apparatus, an unimpeded flow of the medium from this tubular section into the further tubular section of the separating apparatus is ensured, and without having to overcome a step that reduces the internal cross-section of the separating apparatus.

In one embodied example of the device according to the invention for separating media, the front face of the housing of the bypass valve that is directed away from the outlet point for the fluid is formed by a ring-shaped step in the allocated tubular section of the separating apparatus.

The correspondingly ring-shaped step is embodied particularly by an expansion of the outer diameter of the separating apparatus in this region. The step that is thus formed thereby enters the fluid space that is formed between the separating apparatus and the filter device.

In one embodied example of the device according to the invention for separating media, the front face of the housing of the bypass valve that is directed away from the outlet point for the fluid includes perforations for the entry of the medium. A valve element that is held against the front face by an energy store provides a sealing cover for the perforations. Due to the step-type front face of the housing of the bypass valve that is formed between the separating apparatus and filter device, it is possible for the medium in the fluid space to flow against the perforations provided therein. If the medium has a sufficiently high pressure, the valve element that is held against the front face is displaced against the effect of the energy store, which causes the perforations to be exposed and for medium to be able to flow directly to the outlet point via the bypass valve. The valve element herein is formed, in particular, as a ring with a rectangular cross-section, and the energy store is formed, for example, by a spring that rests against the valve element. At the free end of the housing, which is disposed opposite to the front face of the housing of the bypass valve and formed by the step, a ring, which is connected to the free end of the housing of the bypass valves, can serve as a further mating surface for a corresponding ring, particularly one having a rectangular cross-section. The inside diameter of the corresponding ring constitutes the outlet point for the fluid exiting the separating apparatus, while the outside of the ring forms the mating surface for the spring.

In one embodied example of the device according to the invention for separating media, the filter device and the separating apparatus, as well as the bypass valve and the further bypass valve, constitute parts of a standardized component that can be inserted as a whole into a device housing. Accordingly, the essential parts of the device for separating media can be easily replaced.

Due to the fact that the filter device, as well as the separating apparatus and the bypass valve, as well as the further bypass valve are replaced as a full standardized component, when such a replacement step is implemented, the operational reliability of the device for separating media according to the invention is further improved. By replacing a complete standardized component any component errors that can occur when replacing individual parts are effectively avoided.

The standardized component as a whole can be inserted in a device housing of the device for separating media, wherein the corresponding device housing includes a hollow cylindrical middle part to which a base part and a head part, respectively, can be attached in order to enclose the device housing against the exterior. A connection of the head and/or base part with the middle part can be provided therein, for example, by a screwed connection, such that the described replacement of the standardized component is easily achieved in that the base and/or head part(s) is (are) removed from the device housing by loosening the screwed connection. The standardized component can thus be easily removed from the device and replaced with a new or overhauled standardized component.

In one embodied example, one or a plurality of measuring connections are respectively disposed in the head and/or base part of the device housing, for example, serving to detect pressure, flow rate or viscosity of the fluid and/or medium. Furthermore, the base part of the device housing also constitutes a receiving space for the preload valve that is preferably disposed in the base part of the device housing, particularly disposed coaxially relative to the longitudinal axis of the device and aligned with the outlet point for the fluid of the separating apparatus.

In one embodied example of the device according to the invention, for the purpose of supporting the filter mat web, the same is coaxially internally supported by a flared spiral-shaped support tube configured at the respectively neighboring edges of the windings of the spiral. The support tube is perforated thereby, such that the medium passing through the filter mat web flows through the radial width of the support tube such that the entry of the medium into the fluid space that is formed between the separating apparatus and the filter device is made possible. The flares intended to connect the support tube, which is configured in a spiral shape, are preferably executed on the inside of the support tube. By a suitable cutting of the starting material to the appropriate size for the support tube, which is preferably made of a band-shaped, metallic material, the support tube is easily adjusted to the given longitudinal extension of the device for separating media. Moreover, different diameters of the support tube are easily achieved. Aside from the actual connection of the individual windings of the spiral of the support tube by means of flaring, the same also help to reinforce the stiffness the support tube, such that the tube maintains the shape thereof even in the presence of medium flowing against the enclosing outer surface thereof at a high pressure.

Further advantageous embodied examples according to the invention that illustrate a device for separating media are the subject matter of the further dependent claims.

Below, the device for separating media will be described in further detail based on one embodiment as depicted in the drawings. Shown are representations in principle that are not drawn to scale.

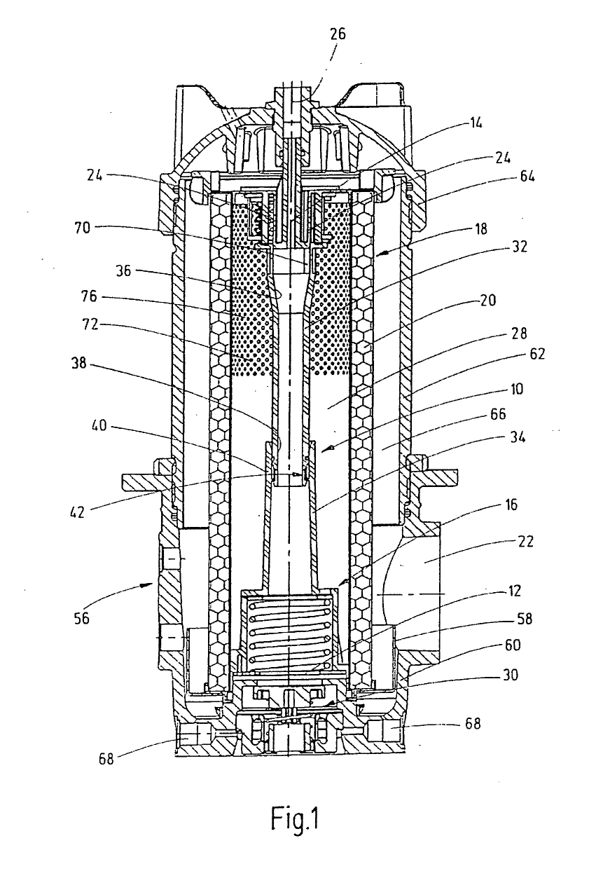

FIG. 1 shows a longitudinal section of an embodiment of the device for separating media;

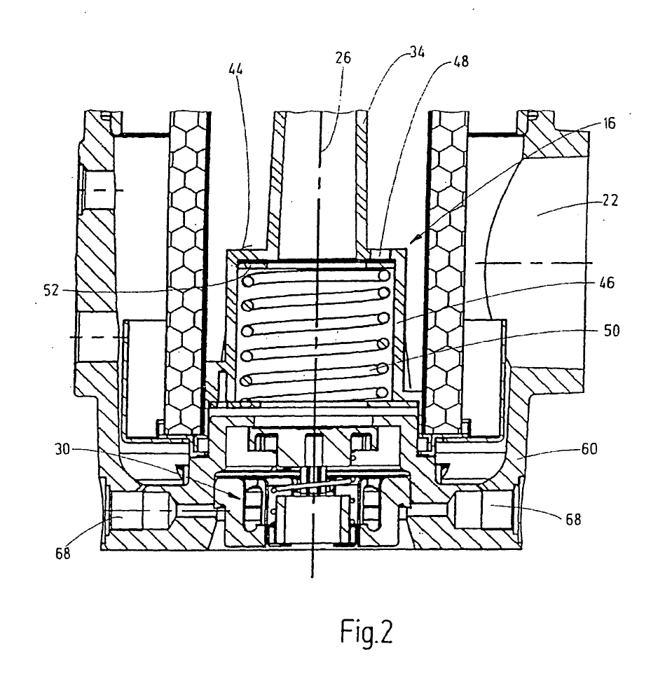

FIG. 2 shows an enlarged section of the representation according to FIG. 1;

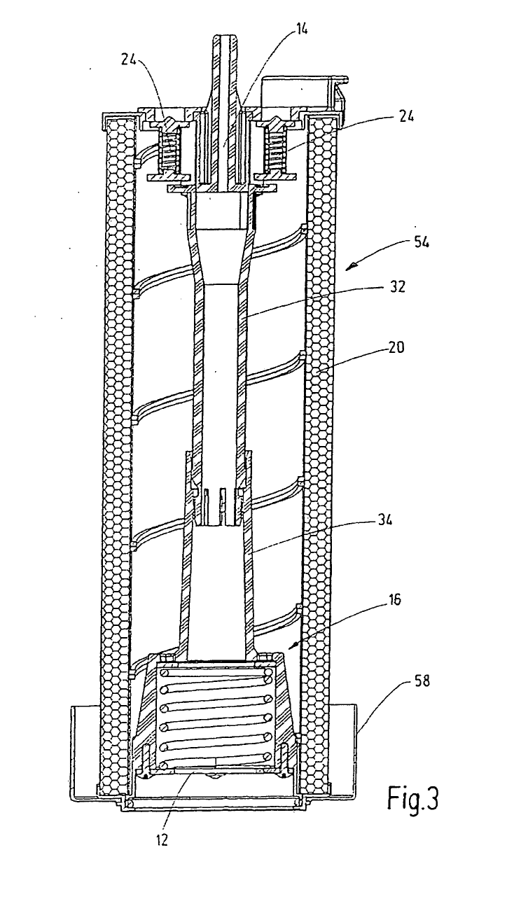

FIG. 3 shows a longitudinal section of a standardized component that is an inner part of the device for separating media;

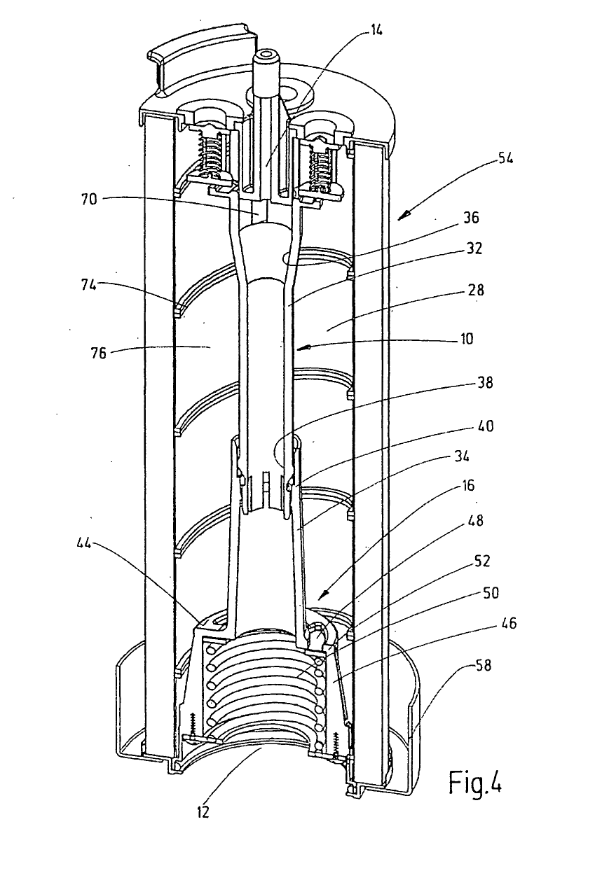

FIG. 4 shows a longitudinal section of a perspective view of a standardized component according to FIG. 3.

The device for separating media according to the invention, particularly for separating gases, such as air, from a fluid, such as oil, includes a separating apparatus 10 which causes the medium to rotate upon entering the separating apparatus for the purpose of carrying out the separation, and which has one outlet point 14 for gas and one outlet point 12 for fluid. Seen with the perspective of FIG. 1, the outlet point 12 for fluid is disposed at the bottom end of the separating apparatus 10, while the outlet point 14 for the gas is formed at the top end of the separating apparatus 10. A bypass valve, as a whole designated by the numeral 16, is disposed downstream of the fluid flow and upstream of the outlet point 14 for the fluid, and at least a part of the medium flows, bypassing the region of the separating apparatus 10 provided for the separation of the gas from the fluid, to the outlet point 12 for the fluid, provided the medium exerts a sufficient amount of pressure in the region of the bypass valve 16 for opening said bypass valve 16.

The separating apparatus 10 has a tubular shape, and the bypass valve 16 encloses the separating apparatus 10; seen from the perspective in FIG. 1, at the bottom end thereof forming at the free end thereof the outlet point 12 for fluid and/or medium.

Extending along the separating apparatus 10, the same is framed by a filter device, as a whole designated by the numeral 18, which includes at least one filter mat web 20 and the medium, which is supplied by means of the media supply 22 of the device, traverses the filter mat web 20 toward the separating apparatus 10. The filter mat web 20 is supported on the inside by means of a support tube 76, which is provided with a perforation 72 for the passage of the fluid. The spiral-shaped support tube is produced by means of flares 74 (see FIG. 4) from a band-shaped and perforated starting material.

Aside from the bypass valve 16 for circumventing the separating apparatus, a further bypass valve 24 is provided in the device according to the invention by means of which at least a part of the medium flows to the outlet point 12 for the fluid, while bypassing the filter device 18, provided the filter device 18 counteracts the flow of medium through the filter device 18, particularly due to contamination of the filter device, with a flow resistance generating a pressure of the medium that opens the further bypass valve 24 as a consequence.

In the embodied example according to the figures, a total of four bypass valves 24 is provided that are disposed diagonally opposite relative to a longitudinal axis 26 of the device for separating media. It is understood that solutions with only one bypass valve 24 can be implemented as well; however, the increased number of bypass valves 24 further enhances the operational reliability of the device for separating media because, even if one of the bypass valves 24 fails, the remaining bypass valves 24 reliably take over the function that is assigned to them. By a symmetrical arrangement of the bypass valves with regard to the longitudinal axis 26 of the device, a uniform flow in the direction of the circumference in the fluid space 28 that is disposed between the separating apparatus 10 and the filter device 18 is ensured in as much as possible, provided the medium enters through the one and/or plurality of the bypass valves 24 into said space.

In the embodiment according to FIG. 1, the further bypass valve 24 is disposed at the end of the separating apparatus 10 that is opposite relative to the end where the bypass valve 16 of the separating apparatus is disposed. This corresponding configuration ensures an unimpeded flow to the bypass valve 16 by the media flow which enters via the further bypass valve 24.

Seen in the flow direction, a preload valve 30 is disposed downstream of the separating apparatus 10 at the outlet point 12 for fluid, which ensures that the fluid and/or media flow exiting the device has a minimum pressure. Particularly in hydraulic systems, it is often absolutely necessary to ensure that the hydraulic fluid has a minimum pressure to avoid damaging the components of the hydraulic system, such as, for example, drive systems for wind power facilities and the like.

The tubular section 32 of the separating apparatus 10 that is adjacent to the outlet point 14 for gas has an inside diameter over a part 36 of the longitudinal extension of the section 32 that is tapered toward the outlet point 12 for fluid, as shown particularly in FIG. 4, that supports the separation of gas from the fluid in the manner of a cyclone separator. The entry of the fluid into the separating apparatus 10 occurs therein, seen from the perspective in FIG. 4, above the part 36 via a single or a plurality of slots 70 in section 32 of the separating apparatus 10 by means of which the fluid flows tangentially into the interior space of the separating apparatus 10.

Seen at a perspective as in FIG. 1, the separating apparatus 10 includes the top, tubular section 36 that is directed toward the top section allocated to the cyclone separator as well as a bottom, further tubular section 34, and the two are disposed coaxially in the assembled state providing a sealing action that is reciprocal.

The end regions 38 and 40 of the two tubular section 32 and 34 of the separating apparatus 10, which are directed toward each other, are axially overlapping, wherein, in the embodied example, as illustrated in FIG. 1, the end region 38 of the tubular section 32 is inserted into the other end region 40 of the tubular section 34 of the separating apparatus 10. Using a fastening means 42, the end region 38 is fixed on the end region 40, such that the two tubular sections 32 and 34 are axially fixed in position, creating overall a stable, tubular structure of the separating apparatus 10.

As illustrated in FIG. 2, in particular, in the enlarged section of the representation from FIG. 1, the front face 44 of the housing 46 of the bypass valve 16 that is directed away from the outlet point 12 for the fluid is formed by a ring-shaped step in the allocated tubular section 34 of the separating apparatus 10. Correspondingly, a simple enlargement of the diameter of the section 34 of the separating apparatus serves to embody the front face 44 as well as the overall pot-shaped housing 46 of the bypass valve 16.

As can be derived, in particular, from FIG. 4, the front face 44 of the housing 46 of the bypass valve 16 that is directed away from the outlet point 12 for the fluid is provided with perforations 48 for the entry of medium. The energy store 50 that is implemented as a spring in the embodiment, is a valve element 52 resting against the front face 44 of the housing 46 of the bypass valve, thereby sealing the perforations 48. When the pressure increase of the medium in the fluid space 28 is high enough, the valve element 48 is pushed in a downward direction, as seen in FIG. 4, against the effect of the energy store 50,

such that the perforations 48 are exposed for the entry of medium into the bypass valve 16.

As depicted in FIGS. 3 and 4, the filter device 18, the separating apparatus 10, as well as the bypass valve 16 and the further bypass valve 24, constitute parts of one standardized component 54 that can be used as a whole in the device housing 56 (see FIG. 1).

Seen from the perspective of FIG. 4, a dirt-collecting basin 58 is disposed at the bottom end of standardized component 54, which is, in the installed state (see FIG. 1), below the media inflow 22 circumferentially framing the filter mat web and leaving a gap, which is provided particularly for the purpose of receiving larger dirt particles that make contact with the filter mat web 20, such that, on the one hand, they cannot interfere with the further media flow and, on the other hand, they can be discarded together with the standardized component 54, when the component is replaced.

The device housing 56, into which the standardized component 54 can be inserted as a whole, includes a cylindrical, tubular middle part 62 that coaxially surrounds the standardized component 54 relative to the longitudinal axis 26 of the device as well as, furthermore, a head part 64 that encloses the device housing 56 towards the top, and a base part 60 that encloses the device housing 56 toward the bottom. Furthermore, the base part 60 also includes a media inlet 22 that is able to supply medium to the device. The base part 60 as well as the head part 64 are connected in the shown embodied example with the middle part 62 of the device housing 56 by way of screwed connections, such that upon loosening the base part 60 or the head part 64 a quick replacement of the standardized component 54 can be undertaken. By the radial distance of the inside diameter, particularly of middle part 62 of the device housing 56, from the outside diameter of the standardized component 54, an inflow space 66 is created which is penetrated first by the medium supplied to the device

prior to passing through the filter unit in order to reach the fluid space 28.

The base part 68 provides a receiving space for the preload valve 30. The preload valve 30 is disposed concentrically relative to the longitudinal axis 26 of the device and in alignment with the outlet point 12 for fluid of the separating apparatus 10. In the flow direction of the fluid, it follows the bypass valve 16 closely, such that the filtered fluid, which has been freed of gases, flows from the device via the preload valve 30.

Measuring connections 68 are provided in the base part 60 of the device housing 56 that, seen in the embodiment, radially penetrate the wall of the base part 60 and that are in communication with the fluid. Using the measuring connections 68, it is possible to detect parameters of the fluid such as, for example, pressure, flow rate, viscosity or temperature by means of measuring devices that are presently not shown in further detail.

1. A device for separating media, in particular for removing gases, such as air, from a fluid, such as oil, comprising a separating apparatus (10), which causes the medium to rotate upon entering the separating apparatus for the purpose of carrying out the separation and which has one outlet point (14, 12) each for the gas and for the fluid, characterized in that the separating apparatus (10) has a bypass valve (16) that is disposed downstream of the fluid flow and upstream of the outlet point (12) for the fluid through which at least a part of the medium flows to the outlet point (12) for the fluid in order to bypass the region of the separating apparatus (10) designed to remove gas from the fluid, provided the medium in the vicinity of the bypass valve (16) exerts a pressure sufficient to open the bypass valve (16).

2. The device according to claim 1, characterized in that the separating apparatus (10) is tubular, and in that the bypass valve (16) encloses the separating apparatus (10) on one end and constitutes the outlet point (12) for the fluid/medium at the free end thereof.

3. The device according to an claim 1, characterized in that extending along the separating apparatus (10) the same is framed by a filter device (18) that includes at least one filter mat web (20), and in that the medium traverses the filter mat web (20) in the direction of the separating apparatus (10).

4. The device according to claim 1, characterized in that the device includes a further bypass valve (24) by which at least a part of the medium, while bypassing the filter device (18), flows to the outlet point (12) for the fluid, provided the filter device (18) creates a flow resistance, particularly due to contamination of the filter device (18), against the flow of the medium through the filter device (18), and in that the resulting pressure of the medium opens the further bypass valve (24).

5. The device according to claim 1, characterized in that the further bypass valve (24) is disposed on the end of the separating apparatus (10) that is located opposite to the end where the bypass valve (16) of the separating apparatus (10) is disposed.

6. The device according to claim 1, characterized in that downstream of the separating apparatus (10), seen in the direction of the flow, a preload valve (30) is disposed at the outlet point (12) to ensure a minimum pressure of the fluid/medium exiting the device.

7. The device according to claim 1, characterized in that the separating apparatus (10) has at least two tubular sections (32, 34) that can be separated from each other and that are coaxially disposed relative to each other as well as providing sealing action against each other, when they are in the assembled state.

8. The device according to claim 1, characterized in that the tubular section (32) of the separating apparatus (10) that is adjacent to the outlet point (14) for gas has a tapered inside diameter in the longitudinal extension of section (32) over a part (36) in the direction of the outlet point (12) for fluid that supports the separation of the gas from the fluid in the manner of a cyclone separator.

9. The device according to claim 1, characterized in that the end regions (38, 40) of the at least two tubular sections (32, 34) of the separating apparatus (10) that are directed toward each other are axially overlapping, particularly in that one of the end regions (38) is inserted in the other end region (40) and fixed therein by fastening means (42).

10. The device according to claim 1, characterized in that the front face (44) of the housing (46) of the bypass valve (16) that is directed away from the outlet point (12) for the fluid is constituted of a ring-shaped step in the associated tubular section (34) of the separating apparatus (10).

11. The device according to claim 1, characterized in that the front face (44) of the housing (46) of the bypass valve (16) that is directed away from the outlet point (12) for the fluid includes perforations (48) for the entry of medium, and in that a valve element (52) that is held against the front face (44) by an energy store (50) covers the perforations (48) in a sealing manner.

12. The device according to claim 1, characterized in that the filter device (18) and the separating apparatus (10) as well as the bypass valve (16) and the further bypass valve (24) constitute parts of a standardized component (54) that can be inserted as a whole into a device housing (56).
